(19) United States
(12) Patent Application Publication
(10) Pub. No.: US 2012/0149822 A1
(43) Pub. Date: Jun. 14, 2012

(54) PNEUMATIC OBJECT PROVIDED WITH A GASTIGHT LAYER MADE OF A THERMOPLASTIC ELASTOMER AND LAMELLAR FILLER

(75) Inventors: Vincent Abad, Chamalieres (FR); Emmanuel Custodero, Chamalieres (FR); Vincent Lemal, Loubeyrat (FR)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 13/386,309

(22) PCT Filed: Jul. 22, 2010
(86) PCT No.: PCT/EP2010/060631

§ 371 Date: Mar. 2, 2012

(30) Foreign Application Priority Data
Jul. 23, 2009 (FR) 0955157

(51) Int. Cl. C08K 3/36; C08L 53/00

(52) U.S. Cl. 524/449; 524/505; 524/451

(57) ABSTRACT

An inflatable object is equipped with a layer for sealing in an inflation gas. The layer is formed of an elastomeric composition that includes a predominant elastomer by weight, a block thermoplastic elastomer, and a lamellar filler. The block thermoplastic elastomer includes a polyisobutylene block with a number-average molecular mass ranging from 25,000 to 350,000 g/mol and a glass transition temperature of less than or equal to −20° C., and, at at least one end of the polyisobutylene block, a thermoplastic block made from at least a polymerized monomer other than a stirene monomer, the polymerized monomer having a glass transition temperature greater than or equal to 100° C. The lamellar filler has an equivalent diameter (Dᵥ (0.5)) of between 15 and 60 micrometers and an aspect ratio (F) of greater than 65.

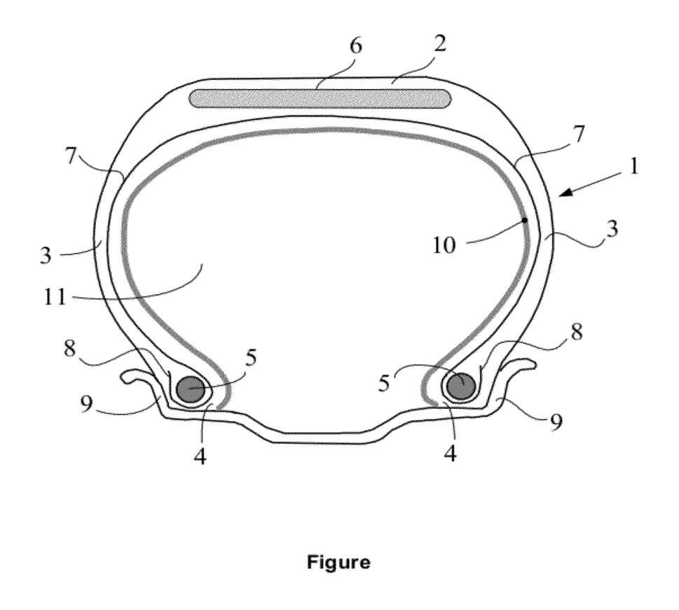

The present invention relates to [symbol] inflatable [symbol] objects, i.e., by definition, objects that take their working shape when they are inflated with air or an equivalent inflation gas.

The invention relates more particularly to the gastight layers that ensure the sealing of these inflatable objects, in particular that of pneumatic tires.

In a conventional pneumatic tire of the [symbol] tubeless [symbol] type (i.e. without an inner tube), the radially inner face comprises a layer that is airtight (or more generally impermeable with respect to any inflation gas) for inflating the pneumatic tire and keeping it under pressure. Its sealing properties ensure relatively low pressure loss, making it possible to keep the tire inflated in the state of normal functioning for a sufficient duration, normally for several weeks or several months. It also has a function of protecting the carcass reinforcement against the diffusion of air originating from the inner space of the tire.

This function as an airtight inner layer or [symbol] inner liner [symbol] is currently fulfilled by compositions based on butyl rubber (copolymer of isobutylene and isoprene), which have been known for a very long time for their excellent sealing properties.

However, a well-known drawback of compositions based on butyl elastomer or rubber is that they have large hysteretic losses, and what is more, over a broad temperature spectrum, this drawback penalizes the rolling resistance of pneumatic tires.

Reducing the hysteresis of these inner sealing layers and thus, ultimately, the fuel consumption of motor vehicles, is a general objective with which the current technology is confronted.

In the prior patent applications FR 08/57844 and FR 08/57845, the Applicants describe a novel thermoplastic elastomer of SIBS type. This novel SIBS, when used in a composition optionally extended with an extender oil, induces surprising and unexpected dynamic properties in said composition, which make this composition particularly suitable for manufacturing inner sealing layers, especially for motor vehicle tires. Advantageously, this SIBS allows the production of inner sealing layers that have improved hysteresis properties while at the same time affording these said inner layers very good sealing properties and a capacity for adhesion to the rubber components adjacent thereto.

Besides the improved hysteresis properties, the improvement of the heat resistance of compositions for inner sealing layers is a continuous axis of research especially with a view to ensuring good cohesion of the composition when hot, even under extreme working conditions, for instance running at very high speed or in an environment whose ambient temperature is high, or alternatively during the annealing of tires during which the temperatures may reach more than 200° C.

The heat resistance of a block thermoplastic elastomer is a function of the value of the glass transition temperature and/or of the melting point of the thermoplastic blocks. For certain applications, the value of the glass transition temperature of the side blocks of certain SIBSs is insufficient and does not make it possible to envision the use of these SIBSs for producing inner sealing layers subjected especially to extreme working conditions.

The aim of the present invention is thus to improve the thermal behaviour of thermoplastic elastomer-based compositions, while at the same time maintaining good sealing properties, and also hysteresis properties that are satisfactory for use in tires.

In the continuance of their research, the Inventors have discovered that the use of certain block thermoplastic elastomers in elastomeric compositions for airtight layers gives these compositions good hot cohesion, especially at temperatures above 100° C., or even above 150° C. In addition, these specific thermoplastic elastomers combined with a judicial choice of platy fillers give the compositions containing them good sealing properties and also hysteresis properties that are satisfactory for use in inflatable objects and more particularly in pneumatic tires.

Thus, the present invention relates to an inflatable object equipped with a layer for sealing in inflation gases, the said layer comprising an elastomeric composition comprising at least, as sole elastomer or predominant elastomer by weight, a block thermoplastic elastomer (TPE) and a lamellar filler, characterized in that said block thermoplastic elastomer comprises:
a [symbol] polyisobutylene [symbol] block with a number-average molecular mass ranging from 25 000 g/mol to 350 000 g/mol and a glass transition temperature of less than or equal to −20° C., and
at at least one of the ends of the [symbol] polyisobutylene [symbol] block, a thermoplastic block made from at least one polymerized monomer other than a stirene monomer, whose glass transition temperature is greater than or equal to 100° C.; and in that the said lamellar filler has an equivalent diameter (Dv (0.5)) of between 15 and 60 micrometres and an aspect ratio (F) of greater than 65, with:

$$F = \frac{{S}_{BET}}{{S}_{sphere}} = \frac{ρ {S}_{BET} {D}_{V} ( 0.5 )}{6}$$

in which:
S_{BET} is the specific surface area of the lamellar filler measured by BET in m²/g;
Sₛₚₕₑᵣₑ is the specific surface area of a sphere of identical equivalent diameter (Dv (0.5)) in m²/g;
Dv (0.5) is the equivalent diameter in μm; and
ρ is the mass per unit volume of the lamellar filler in g/cm³.

Preferentially, the equivalent diameter of the lamellar fillers is between 20 and 45 micrometres.

Compared with butyl rubbers, and just like SIBSs, this thermoplastic elastomer of specific structure also has the major advantage, on account of its thermoplastic nature, of being able to be worked in melt form (liquid), and consequently of offering the possibility of simplified implementation.

The invention particularly relates to rubber inflatable objects such as pneumatic tires, or inner tubes, especially pneumatic tire inner tubes.

The invention more particularly relates to pneumatic tires intended for equipping motor vehicles of the passenger type, SUVs (Sport Utility Vehicles), two-wheeled vehicles (especially motorcycles, mopeds), and aircraft, and industrial vehicles chosen from vans, heavy vehicles—i.e. underground trains, buses, heavy road transport vehicles (lorries, towing vehicles, trailers), offroad vehicles such as agricultural or civil engineering vehicles—, other transport or handling vehicles.

In the present description, unless expressly mentioned otherwise, all the percentages (%) are indicated as mass percentages.

In the description of the invention that follows, the terms [symbol] block thermoplastic elastomer [symbol] , [symbol] block thermoplastic elastomeric copolymer [symbol] and [symbol] block copolymer [symbol] are equivalent and may be used indiscriminately.

Moreover, any range of values denoted by the term ( [symbol] between a and b [symbol] represents the range of values going from more than a to less than b (i.e. limits a and b excluded), whereas any range of values denoted by the term [symbol] from a to b [symbol] means the range of values going from a up to b (i.e. including the strict limits a and b).

Thus, a first subject of the invention is an inflatable object comprising an airtight layer comprised of an elastomeric composition comprising at least, as majority (by weight) elastomer, one block thermoplastic elastomer of specific structure.

This block thermoplastic elastomer of specific structure is a block copolymer comprising at least one [symbol] polyisobutylene [symbol] elastomeric block composed predominantly of polymerized isobutene monomer and, at at least one of the ends of the elastomeric block, a thermoplastic block formed from at least one polymerized monomer, other than a stirene monomer, the glass transition temperature (Tg, measured according to ASTM D3418) of said polymer constituting the thermoplastic block is greater than or equal to 100° C. This block thermoplastic elastomeric copolymer has the following structural characteristics:
1) the [symbol] polyisobutylene [symbol] block has a number-average molecular mass (“Mn”) ranging from 25 000 g/mol to 350 000 g/mol and a glass transition temperature (“Tg”) of less than or equal to −20° C.,
2) the thermoplastic block(s) with an upper glass transition temperature (“Tg”) of greater than or equal to 100° C. and formed from at least one polymerized monomer, other than a stirene monomer.

According to a first variant of the invention, the block thermoplastic elastomeric copolymer is in a linear diblock form. The block copolymer is then composed of a [symbol] polyisobutylene [symbol] block and a thermoplastic block.

According to a particularly preferred variant of the invention, the thermoplastic elastomeric block copolymer is in a linear triblock form. The block copolymer is then composed of a central [symbol] polyisobutylene [symbol] block and two terminal thermoplastic blocks, at each of the two ends of the [symbol] polyisobutylene [symbol] block.

According to another variant of the invention, the thermoplastic elastomeric block copolymer is in a star form with at least three arms. The block copolymer is then a star [symbol] polyisobutylene [symbol] block with at least three arms and a thermoplastic block, located at the end of each of the arms of the [symbol] polyisobutylene [symbol] . The number of [symbol] polyisobutylene [symbol] arms ranges from 3 to 12 and preferably from 3 to 6.

According to another variant of the invention, the thermoplastic elastomeric block copolymer is in a branched or dendrimer form. The block copolymer is then composed of a branched or dendrimer [symbol] polyisobutylene [symbol] block and of a thermoplastic block, located at the end of the arms of the dendrimer [symbol] polyisobutylene [symbol] .

The number-average molecular mass (noted Mn) of the block copolymer is preferentially between 30 000 and 500 000 g/mol and more preferentially between 40 000 and 400 000 g/mol. Below the indicated minima, the cohesion between the elastomeric chains of the TPE, especially on account of its possible dilution (in the presence of an extender oil), risks being affected; moreover, an increase in the working temperature risks affecting the mechanical properties, especially the properties at failure, with as a consequence reduced “hot” performance. Moreover, an excessively high mass Mn may be penalizing on the flexibility of the gastight layer. Thus, it has been found that a value within a range from 50 000 to 300 000 g/mol was particularly suitable, especially for a use of the block copolymer in a pneumatic tire composition.

The number-average molecular mass (Mn) of the TPE elastomer is determined in a known manner, by steric exclusion chromatography (SEC). The sample is predissolved in tetrahydrofuran to a concentration of about 1 g/l; the solution is then filtered through a filter of porosity 0.45 μm before injection. The apparatus used is a Waters Alliance chromatography line. The elution solvent is tetrahydrofuran, the flow rate is 0.7 ml/minute, the temperature of the system is 35° C. and the analysis time is 90 minutes. A set of four Waters columns in series is used, having the trade name Styragel (HMW7, HMW6E and two HT6E columns). The injected volume of the solution of the polymer sample is 100 μl. The detector is a Waters 2410 differential refractometer and its associated software for exploiting the chromatographic data is the Waters Millennium system. The average molecular masses calculated are relative to a calibration curve produced with polystirene standards.

The value of the polydispersity index Ip (reminder: Ip=Mw/Mn with Mw being the weight-average molecular mass and Mn being the number-average molecular mass) of the block copolymer is preferably less than 3; more preferentially less than 2 and even more preferentially less than 1.5.

According to the invention, the [symbol] polyisobutylene [symbol] block of the block copolymer is predominantly composed of isobutene-based units. The term “predominantly” means the highest weight content of monomer relative to the total weight of the [symbol] polyisobutylene [symbol] block, and preferably a weight content of more than 50%, more preferentially more than 75% and even more preferentially more than 85%.

According to the invention, the [symbol] polyisobutylene [symbol] block of the block copolymer has a number-average molecular mass (“Mn”) ranging from 25 000 g/mol to 350 000 g/mol and preferably from 35 000 g/mol to 250 000 g/mol so as to give the TPE good elastomeric properties and mechanical strength that is sufficient and compatible with the application as pneumatic tire inner rubber.

According to the invention, the [symbol] polyisobutylene [symbol] block of the block copolymer also has a glass transition temperature (“Tg”) of less than or equal to −20° C. and more preferentially less than −40° C. A Tg value above these minima may reduce the performance of the airtight layer during use at very low temperature; for such a use, the Tg of the block copolymer is even more preferentially less than −50° C.

Advantageously, according to the invention, the [symbol] polyisobutylene [symbol] block of the block copolymer may also comprise a content of one or more conjugated dienes inserted into the polymer chain. The content of diene-based units is defined by the sealing properties that the block copolymer must have. Preferentially, the content of diene-based units ranges from 0.5% to 16% by weight relative to the weight of the [symbol] polyisobutylene [symbol] block, more preferentially from 1% to 10% by weight and even more preferentially from 2% to 8% by weight relative to the weight of the [symbol] polyisobutylene [symbol] block.

The conjugated dienes that may be copolymerized with isobutylene to form the [symbol] polyisobutylene [symbol] block are C₄-C₁₄ conjugated dienes. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene and 1-vinyl-1,3-cyclohexadiene or a mixture thereof. More preferentially, the conjugated diene is isoprene or a mixture containing isoprene.

According to one advantageous aspect of the invention, the [symbol] polyisobutylene [symbol] block may be halogenated and comprise halogen atoms in its chain. This halogenation makes it possible to increase the rate of crosslinking of the composition comprising the block copolymer according to the invention. The halogenation is performed using bromine or chlorine, preferentially bromine, on conjugated diene-based units of the polymer chain of the [symbol] polyisobutylene [symbol] block. Only some of these units react with the halogen. This portion of units derived from reactive conjugated dienes must nevertheless be such that the content of units derived from conjugated dienes that have not reacted with the halogen is at least 0.5% by weight relative to the weight of the [symbol] polyisobutylene [symbol] block.

According to the invention, the thermoplastic block(s) have a Tg of greater than or equal to 100° C. According to one preferential aspect of the invention, the Tg of the thermoplastic block is greater than or equal to 130° C., even more preferentially greater than or equal to 150° C., or even greater than or equal to 200° C.

The proportion of thermoplastic block(s) relative to the block copolymer is determined, on the one hand, by the thermoplasticity properties that said copolymer must have. The thermoplastic blocks with a Tg of greater than or equal to 100° C. must be present in sufficient proportions to preserve the thermoplastic nature of the elastomer according to the invention. The minimum content of thermoplastic blocks with a Tg of greater than or equal to 100° C. in the block copolymer may vary as a function of the working conditions of the copolymer. Moreover, the capacity of the block copolymer to become deformed during the conformation of the tire may also contribute towards determining the proportion of thermoplastic blocks with a Tg of greater than or equal to 100° C.

In the present description, the term “thermoplastic block with a Tg of greater than or equal to 100° C.” should be understood as meaning any polymer based on at least one polymerized monomer other than a stirene monomer, whose glass transition temperature is greater than 100° C. and whose block copolymer according to the invention containing it can be synthesized by a person skilled in the art and has the characteristics defined above.

In the present description, the term “stirene monomer” should be understood as meaning any unsubstituted or substituted stirene-based monomer; among the substituted stirenes that may be mentioned, for example, are methylstirenes (for example o-methylstirene, m-methylstirene or p-methylstirene, α-methylstirene, α-2-dimethylstirene, α-4-dimethylstirene or diphenylethylene), para-tert-butylstirene, chlorostirenes (for example o-chlorostirene, m-chlorostirene, p-chlorostirene, 2,4-dichlorostirene, 2,6-dichlorostirene or 2,4,6-trichlorostirene), bromostirenes (for example o-bromostirene, m-bromostirene, p-bromostirene, 2,4-dibromostirene, 2,6-dibromostirene or 2,4,6-tribromostirene), fluorostirenes (for example o-fluorostirene, m-fluorostirene, p-fluorostirene, 2,4-difluorostirene, 2,6-difluorostirene or 2,4,6-trifluorostirene) or para-hydroxystirene.

In the present description, the term “polymerized monomer other than a stirene monomer” should be understood as meaning any monomer, other than a stirene monomer, polymerized by a person skilled in the art according to known techniques and that may lead to the preparation of block copolymers comprising a [symbol] polyisobutylene [symbol] block according to the invention.

As illustrative but nonlimiting examples, the polymerized monomers other than stirene monomers according to the invention that may be used for the preparation of thermoplastic blocks with a Tg of greater than or equal to 100° C. may be chosen from the following compounds, and mixtures thereof:
acenaphthylene. A person skilled in the art may refer, for example, to the article by Z. Fodor and J. P. Kennedy, Polymer Bulletin 1992 29(6) 697-705;
indene and derivatives thereof, for instance 2-methylindene, 3-methylindene, 4-methylindene, dimethylindenes, 2-phenylindene, 3-phenylindene and 4-phenylindene. A person skilled in the art may refer, for example, to patent U.S. Pat. No. 4,946,899 by the Inventors Kennedy, Puskas, Kaszas and Hager and to documents J. E. Puskas, G. Kaszas, J. P. Kennedy, W. G. Hager Journal of Polymer Science Part A: Polymer Chemistry (1992) 30, 41 and J. P. Kennedy, N. Meguriya, B. Keszler, Macromolecules (1991) 24(25), 6572-6577;
isoprene, then leading to the formation of a certain number of poly(trans-1,4-isoprene) units and of cyclized units according to an intramolecular process. A person skilled in the art may refer, for example, to the documents G. Kaszas, J. E. Puskas, P. Kennedy Applied Polymer Science (1990) 39(1) 119-144 and J. E. Puskas, G. Kaszas, J. P. Kennedy, Macromolecular Science, Chemistry A28 (1991) 65-80;
acrylic acid esters, acrylic acid, crotonic acid, sorbic acid and methacrylic acid esters, acrylamide derivatives, methacrylamide derivatives, acrylonitrile derivatives, methacrylonitrile derivatives, and mixtures thereof. Mention may be made more particularly of adamantyl acrylate, adamantyl crotonate, adamantyl sorbate, 4-biphenylyl acrylate, tert-butyl acrylate, cyanomethyl acrylate, 2-cyanoethyl acrylate, 2-cyanobutyl acrylate, 2-cyanohexyl acrylate, 2-cyanoheptyl acrylate, 3,5-dimethyladamantyl acrylate, 3,5-dimethyladamantyl crotonate, isobornyl acrylate, pentachlorobenzyl acrylate, pentafluorobenzyl acrylate, pentachlorophenyl acrylate, pentafluorophenyl acrylate, adamantyl methacrylate, 4-tert-butylcyclohexyl methacrylate, tert-butyl methacrylate, 4-tert-butylphenyl methacrylate, 4-cyanophenyl methacrylate, 4-cyanomethylphenyl methacrylate, cyclohexyl methacrylate, 3,5-dimethyladamantyl methacrylate, dimethylaminoethyl methacrylate, 3,3-dimethylbutyl methacrylate, methacrylic acid, methyl methacrylate, ethyl methacrylate, phenyl methacrylate, isobornyl methacrylate, tetradecyl methacrylate, trimethylsilyl methacrylate, 2,3-xylenyl methacrylate, 2,6-xylenyl methacrylate, acrylamide, N-sec-butylacrylamide, N-tert-butylacrylamide, N,N-diisopropylacrylamide, N-1-methylbutylacrylamide, N-methyl-N-phenylacrylamide, morpholylacrylamide, piperidylacrylamide, N-tert-butylmethacrylamide, 4-butoxycarbonylphenylmethacrylamide, 4-carboxyphenylmethacrylamide, 4-methoxycarbonylphenylmethacrylamide, 4-ethoxycarbonylphenylmethacrylamide, butyl cyanoacrylate, methyl chloroacrylate, ethyl chloroacrylate, isopropyl chloroacrylate, isobutyl chloroacrylate, cyclohexyl chloroacrylate, methyl fluoromethacrylate, methyl phenyl acrylate, acrylonitrile and methacrylonitrile, and mixtures thereof.

According to one variant of the invention, the polymerized monomer other than a stirene monomer may be copolymerized with at least one other monomer so as to form a thermoplastic block with a Tg of greater than or equal to 100° C. According to this aspect, the mole fraction of polymerized monomer other than a stirene monomer, relative to the total number of units of the thermoplastic block, must be sufficient to reach a Tg of greater than or equal to 100° C., preferentially greater than or equal to 130° C., even more preferentially greater than or equal to 150° C., or even greater than or equal to 200° C. Advantageously, the mole fraction of this other comonomer may range from 0 to 90%, more preferentially from 0 to 75% and even more preferentially from 0 to 50%.

By way of illustration, this other monomer capable of copolymerizing with the polymerized monomer other than a stirene monomer may be chosen from diene monomers, more particularly conjugated diene monomers containing 4 to carbon atoms, and monomers of vinylaromatic type containing from 8 to 20 carbon atoms.

When the comonomer is a conjugated diene containing 4 to 12 carbon atoms, it advantageously represents a mole fraction relative to the total number of units of the thermoplastic block ranging from 0 to 25%. As conjugated dienes that may be used in the thermoplastic blocks according to the invention, those described above are suitable, namely isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,5-dimethyl-1,3-hexadiene, 2-neopentylbutadiene, 1,3-cyclopentadiene, 1,3-cyclohexadiene and 1-vinyl-1,3-cyclohexadiene, or a mixture thereof.

When the comonomer is of vinylaromatic type, it advantageously represents a fraction of units relative to the total number of units of the thermoplastic block of from 0 to 90%, preferentially ranging from 0 to 75% and even more preferentially ranging from 0 to 50%. Vinylaromatic compounds that are especially suitable for use include the stirene monomers mentioned above, namely methylstirenes, para-tert-butylstirene, chlorostirenes, bromostirenes, fluorostirenes or para-hydroxystirene. Preferably, the comonomer of vinylaromatic type is stirene.

As illustrative but nonlimiting examples, mention may be made of mixtures of comonomers that may be used for the preparation of thermoplastic blocks with a Tg of greater than or equal to 100° C., formed from indene and stirene derivatives, especially para-methylstirene or para-tert-butylstirene. A person skilled in the art may refer to documents J. E. Puskas, G. Kaszas, J. P. Kennedy, W. G. Hager, Journal of Polymer Science part A: Polymer Chemistry 1992 30, or J. P. Kennedy, S. Midha, Y. Tsungae, Macromolecules (1993) 26, 429.

The block thermoplastic elastomeric copolymers of the invention may be prepared via synthetic processes that are known per se and described in the literature, especially that mentioned in the presentation of the prior art of the present description. A person skilled in the art will know how to select the appropriate polymerization conditions and to regulate the various polymerization process parameters so as to achieve the specific structure characteristics for the block copolymer of the invention.

Several synthetic strategies may be used in order to prepare the copolymers according to the invention.

A first consists of a first step of synthesis of the [symbol] polyisobutylene [symbol] block by living cationic polymerization of the monomers to be polymerized by means of a monofunctional, difunctional or polyfunctional initiator known to those skilled in the art, followed by a second step of synthesis of the thermoplastic block(s) with a Tg of greater than or equal to 100° C. and by adding the monomer to be polymerized to the living polyisobutylene obtained in the first step. Thus, these two steps are consecutive, which is reflected by the sequential addition:
of the monomers to be polymerized for the preparation of the [symbol] polyisobutylene [symbol] block;
of the monomers to be polymerized for the preparation of the thermoplastic block(s) with a Tg of greater than or equal to 100° C.

At each step, the monomer(s) to be polymerized may or may not be added in the form of a solution in a solvent as described below, in the presence or absence of a Lewis acid or base as described below.

Each of these steps may be performed in the same reactor or in two different polymerization reactors. Preferentially, these two steps are performed in one and the same reactor ( [symbol] one-pot [symbol] synthesis).

Living cationic polymerization is conventionally performed by means of a difunctional or poly-functional initiator and optionally a Lewis acid acting as coinitiator in order to form in-situ a carbocation. Usually, electron-donating compounds are added in order to give the polymerization a living nature.

By way of illustration, the difunctional or polyfunctional initiators that may be used for the preparation of the copolymers according to the invention may be chosen from 1,4-bis(2-methoxy-2-propyl)benzene (or dicumyl methyl ether), 1,3,5-tris(2-methoxy-2-propyl)benzene (or tricumyl methyl ether), 1,4-bis(2-chloro-2-propyl)benzene (or dicumyl chloride), 1,3,5-tris(2-chloro-2-propyl)benzene (or tricumyl chloride), 1,4-bis(2-hydroxy-2-propyl)benzene, 1,3,5-tris(2-hydroxy-2-propyl)benzene, 1,4-bis(2-acetoxy-2-propyl)benzene, 1,3,5-tris(2-acetoxy-2-propyl)benzene, 2,6-dichloro-2,4,4,6-tetramethylheptane and 2,6-dihydroxy-2,4,4,6-heptane. Dicumyl ethers, tricumyl ethers, dicumyl halides or tricumyl halides are preferentially used.

The Lewis acids may be chosen from metal halides of general formula MXn where M is an element chosen from Ti, Zr, Al, Sn, P, B and X is a halogen such as Cl, Br, F or I and n corresponds to the degree of oxidation of the element M. Mention will be made, for example, of TiCl₄, AlCl₃, BCl₃, BF₃, SnCl₄, PCl₃ and PCl₅. Among these compounds, TiCl₄, AlCl₃ and BCl₃ are preferentially used, and TiCl₄ even more preferentially.

The electron-donating compounds may be chosen from the known Lewis bases, such as pyridines, amines, amides, esters, sulfoxides and the like. Among these, DMSO (dimethyl sulfoxide) and DMAc (dimethylacetamide) are preferred.

The living cationic polymerization is performed in an apolar inert solvent or in a mixture of apolar and polar inert solvents.

The apolar solvents that may be used for the synthesis of the copolymers according to the invention are, for example, aliphatic, cycloaliphatic or aromatic hydrocarbon-based solvents, such as hexane, heptane, cyclohexane, methylcyclohexane, benzene or toluene.

The polar solvents that may be used for the synthesis of the copolymers according to the invention are, for example, halogenated solvents such as alkyl halides, for instance methyl chloride (or chloroform), ethyl chloride, butyl chloride, methylene chloride (or dichloromethane) or chlorobenzenes (mono-, di- or trichloro).

A person skilled in the art will know how to select the composition of the mixtures of monomers to be used in order to prepare the block thermoplastic elastomeric copolymers according to the invention, and also the appropriate temperature conditions in order to achieve the molar mass characteristics of these copolymers.

As illustrative but nonlimiting examples, and in order to perform this first synthetic strategy, a person skilled in the art may refer to the following documents for the synthesis of block copolymers based on isobutylene and:
acenaphthylene: the article by Z. Fodor and J. P. Kennedy, Polymer Bulletin 1992 29(6) 697-705;
indene: patent U.S. Pat. No. 4,946,899 by the Inventors Kennedy, Puskas, Kaszas and Hager and documents J. E. Puskas, G. Kaszas, J. P. Kennedy, W. G. Hager Journal of Polymer Science Part A: Polymer Chemistry (1992) 30, 41 and J. P. Kennedy, N. Meguriya, B. Keszler, Macromolecules (1991) 24(25), 6572-6577;
isoprene: documents G. Kaszas, J. E. Puskas, P. Kennedy Applied Polymer Science (1990) 39(1) 119-144 and J. E. Puskas, G. Kaszas, J. P. Kennedy, Macromolecular Science, Chemistry A28 (1991) 65-80.

A second synthetic strategy consists in separately preparing:
a [symbol] polyisobutylene [symbol] block that is telechelic or functional at one or more of its chain ends by living cationic polymerization using a monofunctional, difunctional or polyfunctional initiator, optionally followed by a functionalization reaction on one or more chain ends,
thermoplastic block(s), which are living, for example by anionic polymerization, and have a Tg of greater than or equal to 100° C.,
and then in reacting each of them to obtain a block copolymer according to the invention. The nature of the reactive functions at at least one of the chain ends of the [symbol] polyisobutylene [symbol] block and the proportion of living chains in the polymer constituting the thermoplastic block with a Tg of greater than or equal to 100° C., relative to the amount of these reactive functions, will be chosen by a person skilled in the art to obtain a block copolymer according to the invention.

A third synthetic strategy consists in performing, in this order:
the synthesis of a [symbol] polyisobutylene [symbol] block that is telechelic or functional at one or more of its chain ends by living cationic polymerization using a monofunctional, difunctional or poly-functional initiator;
the modification at the end of the chain of this [symbol] polyisobutylene≈ so as to introduce a monomer unit that can be lithiated;
optionally, the further addition of a monomer unit that can be lithiated and that can lead to a species capable of initiating an anionic polymerization, for instance 1,1-diphenylethylene;
finally, the addition of the polymerizable monomer and of optional comonomers anionically.

By way of example, for the use of such a synthetic strategy, a person skilled in the art may refer to the communication from Kennedy and Price, ACS Symposium, 1992, 496, 258-277 or to the article by Faust et al.: Facile synthesis of diphenylethylene end-functional polyisobutylene and its applications for the synthesis of block copolymers containing poly(methacrylate)s, by Dingsong Feng, Tomoya Higashihara and Rudolf Faust, Polymer, 2007, 49(2), 386-393.

The halogenation of the copolymer according to the invention is performed according to any method known to those skilled in the art, especially those used for the halogenation of butyl rubber, and may take place, for example, using bromine or chlorine, preferentially bromine, on the conjugated diene-based units of the polymer chain of the [symbol] polyisobutylene [symbol] block and/or of the thermoplastic block(s).

In certain variants of the invention according to which the thermoplastic elastomer is a star or branched elastomer, the processes described, for example, in the articles by Puskas J. Polym. Sci Part A: Polymer Chemistry, vol. 36, pp 85-82 (1998) and Puskas, J. Polym. Sci Part A: Polymer Chemistry, vol. 43, pp 1811-1826 (2005) may be performed by analogy to obtain star, branched or living dendrimer [symbol] polyisobutylene [symbol] blocks. A person skilled in the art will then know how to select the composition of the mixtures of monomers to be used in order to prepare the copolymers according to the invention and also the appropriate temperature conditions in order to achieve the molar mass characteristics of these copolymers.

Preferentially, the preparation of the copolymers according to the invention will be performed by living cationic polymerization using a difunctional or polyfunctional initiator and by sequential additions of the monomers to be polymerized for the synthesis of the [symbol] polyisobutylene [symbol] block and of the monomers to be polymerized for the synthesis of the thermoplastic block(s) with a Tg of greater than or equal to 100° C.

The block elastomer according to the invention may by itself constitute the elastomeric composition or may be combined, in this composition, with other constituents to form an elastomeric matrix.

If other optional elastomers are used in this composition, the block thermoplastic elastomeric copolymer according to the invention constitutes the elastomer that is in weight majority, i.e. the weight fraction of the block copolymer relative to all of the elastomers is the highest. The block copolymer preferably represents more than 50% and more preferentially more than 70% by weight of all of the elastomers. Such additional elastomers may, for example, be diene elastomers or thermoplastic stirene (TPS) elastomers, in the limit of the compatibility of their microstructures.

As diene elastomers that may be used in addition to the block thermoplastic elastomer described previously, mention may be made especially of polybutadienes (BR), synthetic polyisoprenes (IR), natural rubber (NR), butadiene copolymers, isoprene copolymers and mixtures of these elastomers. Such copolymers are more preferentially chosen from the group formed by butadiene-stirene copolymers (SBR), isoprene-butadiene copolymers (BIR), isoprene-stirene copolymers (SIR), isoprene-isobutylene copolymers (IIR) and isoprene-butadiene-stirene copolymers (SBIR), and mixtures of such copolymers.

As TPE elastomers that may be used in addition to the block thermoplastic elastomer described previously, mention may be made especially of a TPS elastomer chosen from the group formed by stirene/butadiene/stirene block copolymers, stirene/isoprene/stirene and stirene/butylene/stirene block copolymers, stirene/isoprene/butadiene/stirene block copolymers, stirene/ethylene/butylene/stirene block copolymers, stirene/ethylene/propylene/stirene block copolymers, stirene/ethylene/ethylene/propylene/stirene block copolymers, and mixtures of these copolymers. More preferentially, said optional additional TPS elastomer is chosen from the group formed by stirene/ethylene/butylene/stirene block copolymers, stirene/ethylene/propylene/stirene block copolymers and mixtures of these copolymers.

The block copolymer described previously is sufficient by itself to satisfy the gastight function with respect to the inflatable objects in which it may be used.

However, according to one preferential embodiment of the invention, said copolymer is used in a composition that also comprises, as plasticizer, an extender oil (or plasticizing oil) whose function is to facilitate the implementation, particularly the incorporation into the inflatable object by lowering the modulus and increasing the tack power of the gastight layer.

Any extender oil, preferably of weakly polar nature, which is capable of extending or plasticizing elastomers, especially thermoplastic elastomers, may be used. At room temperature (23° C.), these more or less viscous oils are liquid (i.e. as a reminder, substances having the capacity of taking over time the shape of their container), as opposed especially to resins or rubbers, which are solid by nature.

Preferably, the extender oil is chosen from the group formed by polyolefinic oils (i.e. oils derived from the polymerization of olefins, monoolefins or diolefins), paraffinic oils, naphthenic oils (of low or high viscosity), aromatic oils and mineral oils, and mixtures of these oils.

It should be noted that the addition of an extender oil to the SIBS leads to a loss of sealing of the latter, which is variable depending on the type and amount of oil used. However, this loss of sealing may be largely corrected by adjusting the content of lamellar filler.

An oil of the polybutene type is preferentially used, in particular a polyisobutylene oil (abbreviated as “PIB”), which has demonstrated the best compromise of properties compared with the other oils tested, especially a conventional oil of the paraffinic type.

By way of example, polyisobutylene oils are sold especially by the company Univar under the name Dynapak Poly (e.g. Dynapak Poly 190), by Ineos Oligomer under the name Indopol H1200, by BASF under the name Glissopal (e.g. Glissopal 1000) or Oppanol (e.g. Oppanol B12); paraffinic oils are sold, for example, by Exxon under the name Telura 618 or by Repsol under the name Extensol 51.

The number-average molecular mass (Mn) of the extender oil is preferentially between 200 and 25 000 g/mol and even more preferentially between 300 and 10 000 g/mol. For excessively low Mn masses, there is a risk of migration of the oil out of the composition, whereas excessively high masses may lead to excessive rigidification of this composition. An Mn of between 350 and 4000 g/mol, in particular between 400 and 3000 g/mol, has proven to be an excellent compromise for the intended applications, in particular for use in a pneumatic tire.

A person skilled in the art will know how to adjust the amount of extender oil as a function of the particular implementation and working conditions of the composition.

It is preferred for the content of extender oil to be greater than 5 phr and preferably between 5 and 200 phr (parts by weight per hundred parts of total elastomer, i.e. the thermoplastic elastomer plus any other possible elastomer present in the composition or elastomeric layer).

Below the indicated minimum, the elastomeric composition runs the risk of being too rigid for certain applications, whereas beyond the recommended maximum, there is a risk of insufficient cohesion of the composition and of loss of sealing that may be detrimental depending on the application under consideration.

For these reasons, in particular for use of the airtight composition in a pneumatic tire, it is preferred for the content of extender oil to be greater than 10 phr, especially between 10 and 150 phr, more preferentially greater than 20 phr and especially between 20 and 130 phr.

The composition described above may moreover comprise the various additives usually present in the airtight layers known to those skilled in the art. Mention will be made, for example, of reinforcing fillers such as carbon black or silica, nonreinforcing or inert fillers, colorants that may advantageously be used for coloring the composition, plasticizers other than the abovementioned extender oils, protective agents such as antioxidants or antiozonants, UV stabilizers, various processing aids or other stabilizers, a crosslinking system, for example based either on sulphur and/or peroxide and/or bismaleimides or any other means for crosslinking chains, or alternatively promoters suitable for promoting the adhesion to the rest of the structure of the inflatable object.

A second essential element of the gastight layer according to one subject of the invention is the presence of lamellar fillers with given physical characteristics. The Applicants have found that the presence of these lamellar fillers substantially improves the sealing performance of the elastomeric compositions.

These preferential lamellar fillers are such that they have an equivalent diameter (Dᵥ (0.5)) of between 15 and 60 micrometres and an aspect ratio (F) of greater than 65, with:

$$F = \frac{{S}_{BET}}{{S}_{sphere}} = \frac{ρ {S}_{BET} {D}_{V} ( 0.5 )}{6}$$

in which:
S_{BET} is the specific surface area of the lamellar filler measured by BET in m²/g;
Sₛₚₕₑᵣₑ is the specific surface area of a sphere of identical equivalent diameter (Dv (0.5)) in m²/g;
Dv (0.5) is the equivalent diameter in μm; and
ρ is the mass per unit volume of the lamellar filler in g/cm³.

The sealing properties of the compositions are further improved by selecting lamellar fillers whose equivalent diameter Dᵥ (0.5) is between 20 and 45 micrometres.

The Dᵥ (0.5) measurements were performed on a Mastersizer S laser granulometer (Malvern Instruments; presentations 3$$D, Fraunhofer model). The results given correspond to an average of three measurements.

The principle of the apparatus is as follows: a laser beam passes through a cell in which the particles to be analysed are circulated. The objects illuminated by the laser deviate the light from its main axis. The amount of light deviated and the size of the deviation angle allow accurate measurement of the particle size.

The test amount is adjusted as a function of the obscuration obtained: in order for the measurement to be good, the amount of light deviated/absorbed by the sample relative to the incident beam must be between 15% and 35%. All the measurements taken fall within this situation. The test amount is variable according to the samples (from 10 to 80 mg). The lamellar fillers were studied suspended in water or ethanol depending on their nature. A person skilled in the art can adjust the conditions for preparing the suspension so as to ensure its stability, especially by using ultrasonication to prepare the dispersion of the filler in the medium.

The result is in the form of a curve of volume distribution as a function of the particle size. Dᵥ (0.5) corresponds to the diameter below which 50% of the total population is present.

The specific surface area of the lamellar fillers was also measured by nitrogen adsorption, BET method.

The BET method consists in determining the specific surface area from the amount of nitrogen adsorbed at equilibrium in the form of a monomolecular layer at the surface of the analysed material.

Physical adsorption is an equilibrium state that depends on the temperature: the condensation of gaseous molecules onto the surface of the solid is promoted by a lowering of the temperature (liquid nitrogen). The phenomenon is described by an adsorption isotherm representing the amount of gas (nitrogen) adsorbed onto the solid as a function of the pressure.

The measurement is performed on a test amount of between 0.5 and 1.0 g (weighed out to within 0.0001 g) so as to fill the sample tube to ¾ of its capacity.

The sample is degassed for 1 hour at 300° C. (this time is counted from the moment when vacuum is achieved in the sample tube, i.e. about 20 mmHg).

After degassing, the sample tube is weighed to within 0.0001 g so as to know the test amount of the dry sample. The sample tube is positioned in the BET machine. An adsorption isotherm is produced starting from seven relative pressures P/P₀ of between 0.05 and 0.3 P/P₀. The software of the measuring machine calculates the transformed BET and determines the BET surface area of the sample. The measurement result is expressed to within 0.1 m²/g.

P/P₀: pressure of nitrogen in the sample tube/saturating vapour pressure of nitrogen at the measuring temperature.

The aspect ratio (F) of a lamellar filler is defined by the ratio between the real specific surface area S_{BET} measured by the BET nitrogen adsorption method and expressed in m²/g and the specific surface area of a sphere of the same mass per unit volume and of identical equivalent diameter Dᵥ (0.5) Sₛₚₕₑᵣₑ:

$$F = \frac{{S}_{BET}}{{S}_{sphere}} = \frac{ρ {S}_{BET} {D}_{v} ( 0.5 )}{6}$$

Preferentially, the lamellar fillers used in accordance with the invention are chosen from the group formed by graphites and phyllosilicates, and mixtures of such fillers. Among the phyllosilicates, mention will be made especially of clays, talcs, micas and kaolins, these phyllosilicates possibly being modified by a surface treatment, for example.

Lamellar fillers such as micas are preferentially used.

As examples of micas corresponding to the subject of the invention, mention may be made of the micas sold by the company CMMP (Mica-Soft15®), those sold by the company Yamaguchi (A51S, A41S, SYA-21R, SYA-21RS, A21S and SYA-41R) or a mica sold by Merck (Iriodin 153).

The lamellar fillers described above are used in variable amounts of between 2% and 30% by volume and preferably between 3% and 20% by volume of elastomeric composition.

The lamellar fillers whose equivalent diameter Dᵥ (0.5) is between 15 and 60 μm and whose aspect ratio F is greater than 65 can further improve the sealing performance of the sealing layers.

Preferably, lamellar fillers whose equivalent diameter Dᵥ (0.5) is between 20 and 45 μm and whose aspect ratio F is greater than 65 are used. These lamellar fillers even further improve the sealing performance of the sealing layers. Among the cited examples of fillers, the micas A51S, A41S and SYA-21R from Yamaguchi are particularly preferred since their equivalent diameter and aspect ratio characteristics correspond to these preferential values.

Introduction of the lamellar fillers into the elastomeric thermoplastic composition may be performed according to various known processes, for example by mixing in solution, by mixing in bulk in an internal mixer, or by extrusion mixing, especially with a twin-screw extruder. It is particularly important to note that during the introduction of the lamellar fillers into a TPE elastomer in liquid form, the shear forces in the composition are substantially reduced and only very sparingly modify the initial size and aspect ratio distributions of the lamellar fillers.

The block elastomer according to the invention has the advantage, on account of its thermoplastic nature, of being able to be worked in its existing state in [symbol] melt [symbol] form (liquid), and consequently of offering a possibility of simplified implementation of the elastomeric composition containing it.

Moreover, despite its thermoplastic nature, the block elastomer gives the composition containing it good cohesion of the material when hot, especially at temperatures ranging from 100° C. to 200° C.

In addition, the composition according to the invention comprising the block thermoplastic elastomer has improved hysteretic properties when compared with a composition based on butyl rubber.

A subject of the invention is thus an inflatable object equipped with an elastomeric layer that is impermeable to inflation gases such as air, said elastomeric layer being formed from the elastomeric composition comprising at least, as majority elastomer, one block thermoplastic elastomer described above.

Besides the elastomers (thermoplastic and other optional elastomers) described previously, the gastight composition may also comprise, still in a minor weight fraction relative to the block thermoplastic elastomer, polymers other than elastomers, for instance thermoplastic polymers that are compatible with the block thermoplastic elastomer.

The gastight layer or composition described previously is a solid compound, which has elastic behaviour (at 23° C.) and which is especially characterized, by virtue of its specific formulation, by very high flexibility and very high deformability.

The layer or composition based on a block thermoplastic elastomer, with platy fillers, described previously may be used as an airtight layer in any type of inflatable object. Examples of such inflatable objects that may be mentioned include inflatable boats, and balls used for play or sport.

It is particularly suitable for use as an airtight layer (or layer that is impermeable to any other inflation gas, for example nitrogen) in an inflatable object, finished or semifinished product, made of rubber, most particularly in a pneumatic tire for a motor vehicle such as a two-wheeled, passenger or industrial vehicle. The term “industrial vehicles” means vans, heavy-goods vehicles, i.e. coaches, buses, road haulage vehicles (lorries, tractors or articulated vehicles), off-road vehicles such as agricultural or civil engineering machines, and other transportation or works vehicles.

Such an airtight layer is preferentially placed on the inner wall of the inflatable object, but it may also be fully integrated into its internal structure.

The thickness of the airtight layer is preferentially greater than 0.05 mm and more preferentially between 0.1 mm and 10 mm (especially between 0.1 and 1.0 mm).

It will be readily understood that, depending on the specific fields of application, and the dimensions and pressures that come into play, the mode of implementation of the invention may vary, the airtight layer then comprising several preferential ranges of thickness.

When compared with a usual airtight layer based on butyl rubber, the airtight composition described above has the advantage of having markedly lower hysteresis and is thus a sign of offering reduced rolling resistance for pneumatic tires.

In addition, this block thermoplastic elastomer with a Tg of greater than or equal to 100° C., despite its thermoplastic nature, affords the airtight composition containing it good hot cohesion of the material, especially at temperatures ranging from 100° C. to 200° C. These temperatures correspond to the annealing temperatures of pneumatic tires. This high-temperature cohesion allows hot stripping of these tires from the molds without impairing the integrity of the airtight composition containing said block thermoplastic elastomer. This high-temperature cohesion also allows use of the tires under extreme conditions that may induce significant temperature increases within the gastight elastomeric layer.

The gastight elastomer layer described previously may advantageously be used in pneumatic tires for all types of vehicles, in particular passenger vehicles or industrial vehicles.

By way of example, the attached single FIGURE shows very schematically (without being drawn to a specific scale) a radial cross section of a pneumatic tire in accordance with the invention.

This pneumatic tire 1 comprises a crown 2 reinforced with a crown reinforcement or belt 6, two sidewalls 3 and two beads 4, each of these beads 4 being reinforced with a bead wire 5. Mounted on the crown 2 is a tread, which is not shown in this schematic FIGURE. A carcass reinforcement 7 is wound around the two bead wires 5 in each bead 4, the upturn 8 of this reinforcement 7 being arranged, for example, towards the exterior of the tire 1, which is shown here mounted on its rim 9. The carcass reinforcement 7 is, in a known manner, formed from at least one ply reinforced with “radial” cords, for example textile or metallic cords, i.e. these cords are arranged practically parallel to each other and extend from one bead to another so as to form an angle of between 80° and 90° with the median circumferential plane (plane perpendicular to the axis of rotation of the tire which is located halfway between the two beads 4 and passes through the middle of the crown reinforcement 6).

The inner wall of the pneumatic tire 1 comprises an airtight layer 10, for example with a thickness of about 0.9 mm, on the inner cavity 11 side of the pneumatic tire 1.

This inner layer (or “inner liner”) covers the entire inner wall of the pneumatic tire, extending from one sidewall to the other, at least up to the rim flange when the pneumatic tire is in the mounted position. It defines the radially inner face of said tire intended to protect the carcass reinforcement from diffusion of air coming from the inner space 11 of the tire. It allows the pneumatic tire to be inflated and maintained under pressure; its sealing properties must allow it to ensure a relatively low rate of pressure loss, to keep the tire inflated, in the state of normal functioning, for a sufficient duration, normally for several weeks or several months.

In contrast with a conventional pneumatic tire using a composition based on butyl rubber, the pneumatic tire in accordance with the invention uses in this example, as airtight layer 10, a composition based on a block thermoplastic elastomer as described above in which the thermoplastic block(s) have a Tg of greater than or equal to 100° C.

The tire equipped with its airtight layer 10 as described above may be made before or after vulcanization (or curing).

In the first case (i.e. before curing the pneumatic tire), the airtight layer is simply applied conventionally to the desired place, for formation of the layer 10. Vulcanization is then performed conventionally. The block thermoplastic elastomers according to the invention particularly satisfactorily withstand the stresses associated with the vulcanization step.

One manufacturing variant that is advantageous for a person skilled in the art of pneumatic tires will consist, for example during a first step, in laying down the airtight layer directly onto a building drum, in the form of a skim of suitable thickness, before this is covered with the rest of the structure of the pneumatic tire, according to manufacturing techniques that are well known to those skilled in the art.

In the second case (i.e. after curing the pneumatic tire), the airtight layer is applied to the interior of the cured pneumatic tire by any suitable means, for example by bonding, by spraying or extrusion and/or blow-moulding of a film of suitable thickness.

1-18. (canceled)

19. An inflatable object equipped with a layer for sealing in inflation gases, the layer comprising an elastomeric composition that includes:
a predominant elastomer by weight;
a block thermoplastic elastomer (TPE); and
a lamellar filler,
wherein the block thermoplastic elastomer (TPE) includes:
a polyisobutylene block with a number-average molecular mass ranging from 25000 g/mol to 350000 g/mol and a glass transition temperature of less than or equal to 20° C., and,
at at least one end of the polyisobutylene block, a thermoplastic block that includes a polymerized monomer other than a stirene monomer, the polymerized monomer having a glass transition temperature greater than or equal to 100° C., and
wherein the lamellar filler has an equivalent diameter (Dᵥ (0.5)) of between 15 and 60 micrometers and an aspect ratio (F) of greater than 65, with:
$$F = \frac{{S}_{BET}}{{S}_{sphere}} = \frac{ρ {S}_{BET} {D}_{V} ( 0.5 )}{6} ,$$
in which:
S_{BET} is a specific surface area of the lamellar filler measured by BET in m²/g,
Sₛₚₕₑᵣₑ is a specific surface area of a sphere of identical equivalent diameter (Dᵥ (0.5)) in m²/g,
Dᵥ (0.5) is an equivalent diameter in μm, and
ρ is a mass per unit volume of the lamellar filler in g/cm³.

20. An inflatable object according to claim 19, wherein the equivalent diameter (Dᵥ (0.5)) of the lamellar filler is between 20 and 45 micrometers.

21. An inflatable object according to claim 19, wherein the block thermoplastic elastomer (TPE) has a linear triblock structure.

22. An inflatable object according to claim 19,
wherein the block thermoplastic elastomer (TPE) has a star structure with at least three arms and not more than 12 arms, and
wherein the polyisobutylene block is a star block with at least 3 arms and not more than 12 arms, each arm ending with a thermoplastic block.

23. An inflatable object according to claim 19, wherein the block thermoplastic elastomer (TPE) has a dendrimer structure in which the polyisobutylene block is a polyisobutylene dendrimer, each arm of the polyisobutylene dendrimer ending with a thermoplastic block.

24. An inflatable object according to claim 19, wherein the polyisobutylene block includes a content of units derived from one or more conjugated dienes inserted into a polymer chain ranging from 0.5% to 16% by weight relative to a weight of the polyisobutylene block.

25. An inflatable object according to claim 24, wherein the polyisobutylene block is halogenated.

26. An inflatable object according to claim 19, wherein the polymerized monomer is chosen from a group that includes: acenaphthylene, indene, 2 methylindene, 3 methylindene, 4 methylindene, dimethylindenes, 2 phenylindene, 3 phenylindene, 4-phyenylindene, isoprene, acrylic acid, crotonic acid, sorbic acid or methacrylic acid esters, acrylamide derivatives, methacrylamide derivatives, acrylonitrile derivatives, and methacrylonitrile derivatives.

27. An inflatable object according claim 19, wherein the polymerized monomer is copolymerized with a comonomer chosen from conjugated diene monomers containing 4 to 12 carbon atoms and monomers of vinylaromatic type containing from 8 to 20 carbon atoms.

28. An inflatable object according to claim 27, wherein the comonomer is stirene.

29. An inflatable object according to claim 19, wherein the elastomeric composition further includes 5 phr to 150 phr of an extender oil, with phr signifying parts by weight per 100 parts of elastomer.

30. An inflatable object according to claim 19, wherein the lamellar filler is chosen from a group that includes: graphites, phyllosilicates, and mixtures of a combination of graphites and phyllosilicates.

31. An inflatable object according to claim 30, wherein the lamellar filler is chosen from a group that includes: graphites, talcs, micas, and mixtures of a combination of graphites, talcs, and micas.

32. An inflatable object according to claim 31, wherein the lamellar filler is chosen from a group that includes micas.

33. An inflatable object according to claim 19, wherein the airtight layer is positioned on an inner wall of the inflatable object.

34. An inflatable object according claim 19, wherein the inflatable object is a pneumatic tire.

35. An inflatable object according to claim 19, wherein the inflatable object is an inner tube.

36. An inflatable object according to claim 35, wherein the inner tube is a pneumatic tire inner tube.
